(19) United States
(12) Patent Application Publication
(10) Pub. No.: US 2011/0138643 A1
(43) Pub. Date: Jun. 16, 2011

(54) Angle Square

(76) Inventor: JIN-YI GAO, Xinyi Township (TW)

(21) Appl. No.: 12/848,040

(22) Filed: Jul. 30, 2010

(30) Foreign Application Priority Data
Dec. 14, 2009 (TW) 098223415

(51) Int. Cl. B43L 7/10; G01C 9/00

(52) U.S. Cl. 33/451; 33/465

(57) ABSTRACT

An angle square includes a basic ruler, a pivotal ruler and a light-projecting element. The basic ruler includes a space defined therein. The pivotal ruler is pivotally connected to the basic ruler between an idle position in the space and an active position out of the space. The light-projecting element is connected to the pivotal ruler.

### BACKGROUND OF INVENTION

1. Field of Invention

The present invention relates to an angle square and, more particularly, to an angle square including two rulers pivotally connected to each other and at least one light-protecting element attached to at least one of the rulers and used to cast a light beam as an extension of the related ruler.

2. Related Prior Art

A conventional angle square includes two rulers pivotally connected to each other. Some tasks of construction are conducted based on angles measured with the angle square, i.e., the angle defined between the rulers of the angle square. Ropes or strings are used as extensions of the rulers of the angle square in the construction of a large object such as stairs, a fence and a house. It takes workers quite some time to extend the ropes or strings and delays the proceeding of the construction. Moreover, the ropes or strings inevitably drop and cause errors in the measurement of the angle. The use of the angle square in the making of the large object is troublesome, takes a lot of time, and entails errors.

The present invention is therefore intended to obviate or at least alleviate the problems encountered in prior art.

### SUMMARY OF INVENTION

It is the primary objective of the present invention to provide a convenient and precise angle square.

To achieve the foregoing objective, the angle square includes a basic ruler, a pivotal ruler and a light-projecting element. The basic ruler includes a space defined therein. The pivotal ruler is pivotally connected to the basic ruler between an idle position in the space and an active position out of the space. The light-projecting element is connected to the pivotal ruler.

Other objectives, advantages and features of the present invention will be apparent from the following description referring to the attached drawings.

### BRIEF DESCRIPTION OF DRAWINGS

The present invention will be described via detailed illustration of several embodiments referring to the drawings wherein:

FIG. 1 is a perspective view of an angle square according to the first embodiment of the present invention;

FIG. 2 is an exploded view of the angle square shown in FIG. 1;

FIG. 3 is a cross-sectional view of the angle square shown in FIG. 1;

FIG. 4 is a front view of a house which is made using the angle square shown in FIG. 1;

FIG. 5 is a perspective view of an angle square according to the second embodiment of the present invention;

FIG. 6 is a perspective view of an angle square according to the third embodiment of the present invention;

FIG. 7 is an exploded view of the angle square shown in FIG. 6;

FIG. 8 is a front view of the angle square shown in FIG. 6;

FIG. 9 is a front view of the angle square in another angular position than shown in FIG. 8; and

FIG. 10 is a front view of stairs which is made using an angle square according to the fourth embodiment of the present invention.

### DETAILED DESCRIPTION OF EMBODIMENTS

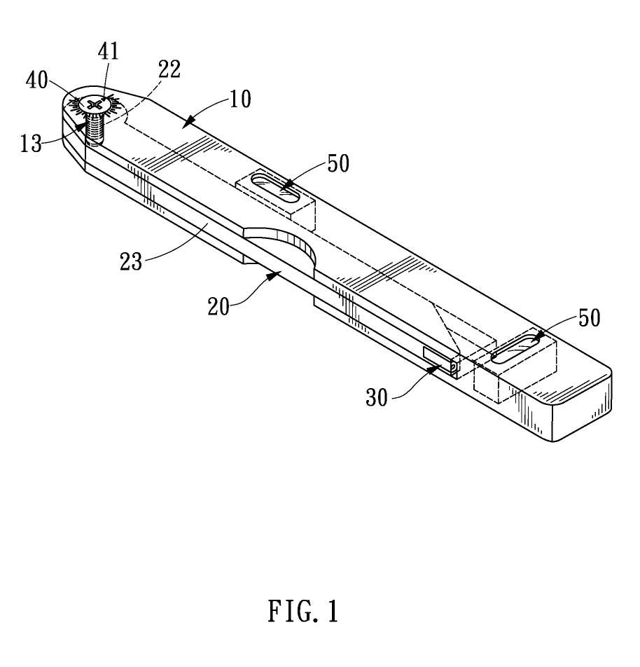

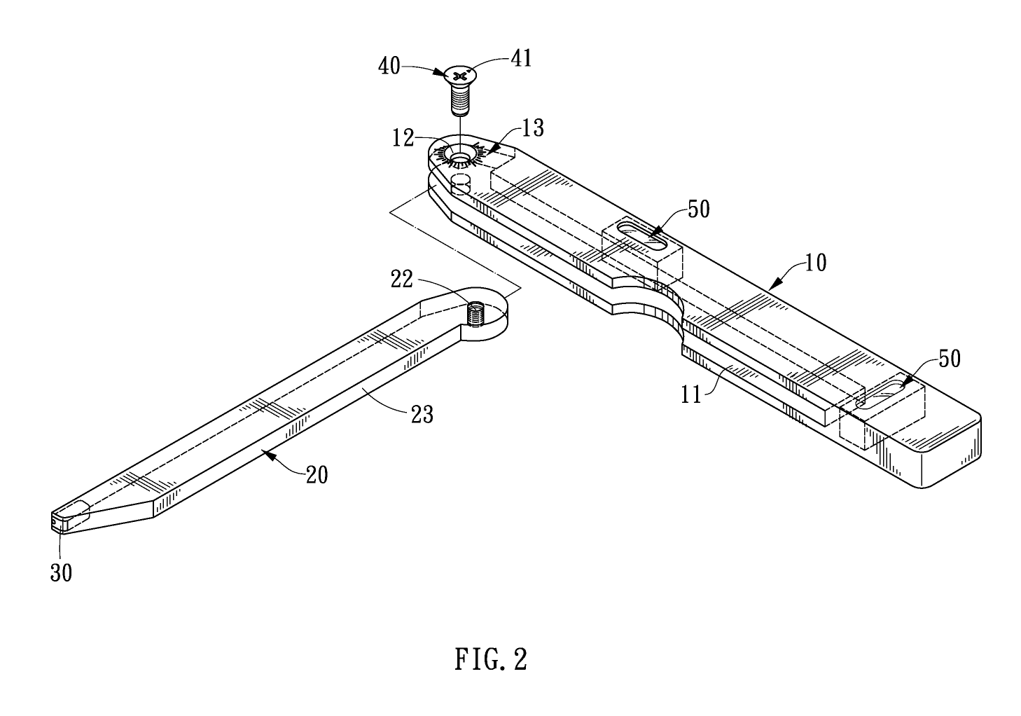

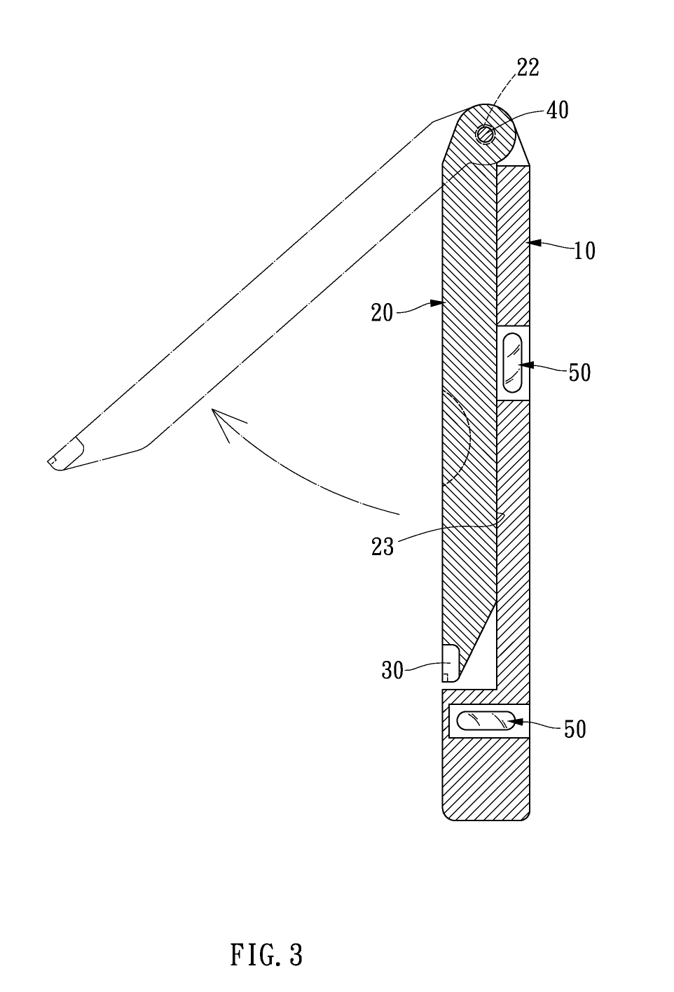

Referring to FIGS. 1 through 3, an angle square includes a basic ruler 10, a pivotal ruler 20, a light-projecting element 30 and a screw 40 according to a first embodiment of the present invention. The basic ruler 10 includes a first end, a second end opposite to the first end, an active edge, and an idle edge preferably but not necessarily in parallel to the active edge. A space 11 is defined in and along the active edge of the basic ruler 10. Thus, the basic ruler 10 is formed with two lateral walls between which the space 11 is defined. Each of the lateral walls includes an aperture 12 defined therein near the first end. One of the lateral walls includes a scale 13 formed on an external side around the aperture 12.

The pivotal ruler 20 includes a first end 21, a second end opposite to the first end 21, an active edge 23, and an idle edge preferably but not necessarily in parallel to the active edge 23. A screw hole 22 is defined in the end 21 of the pivotal ruler 20.

The light-projecting element 30 is located in the second end of the adjustable ruler 20. The light-projecting element 30 is preferably a laser element for casting a laser beam in parallel to the active edge 23 of the adjusting ruler 20.

The screw 40 includes an indicator 41 formed on a head. The screw 40 is driven in the apertures 12 and the screw hole 22 so that the screw 40 spins together with the pivotal ruler 20. The indicator 41 is used together with the scale 13 to show a reading of the angle between the active edge of the basic ruler 10 and the active edge of the pivotal ruler 20.

The angle square preferably includes two levels 50 located on the basic ruler 10. One of the levels 50 extends in parallel to the active edge of the basic ruler 10 while the other level 50 extends in perpendicular to the active edge of the basic ruler 10.

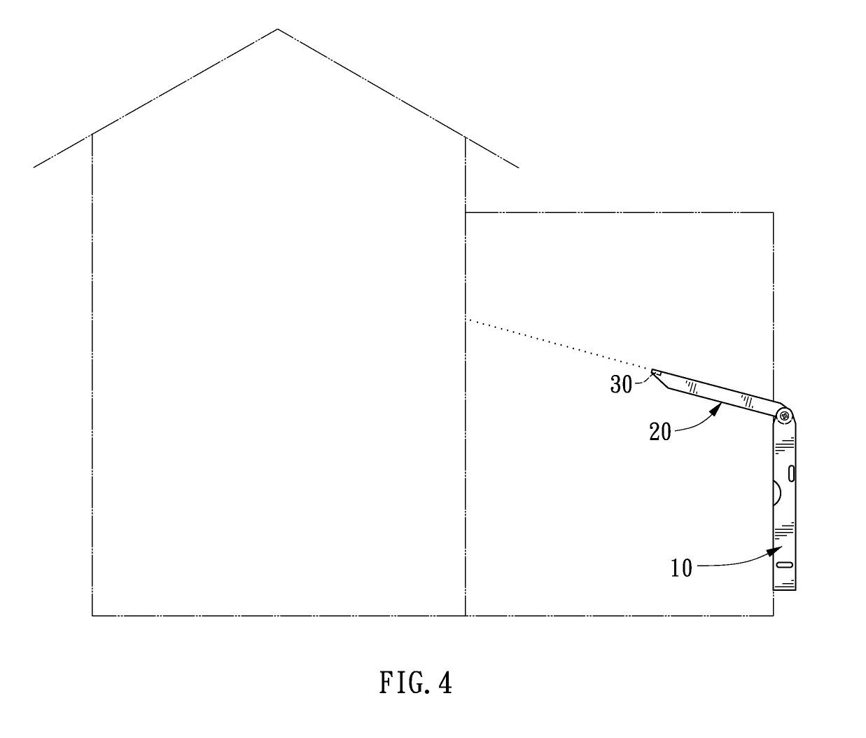

Referring to FIG. 4, the angle square is used in the construction of a fence around a house. The basic ruler 10 is located against a vertical face or edge of the fence. The light-projecting element 30 casts a light beam to a wall of the house. The angle between the basic ruler 10 and the pivotal ruler 20 of the angle square is read and used in the construction of the fence relative to the house. The height of the fence is determined readily and precisely.

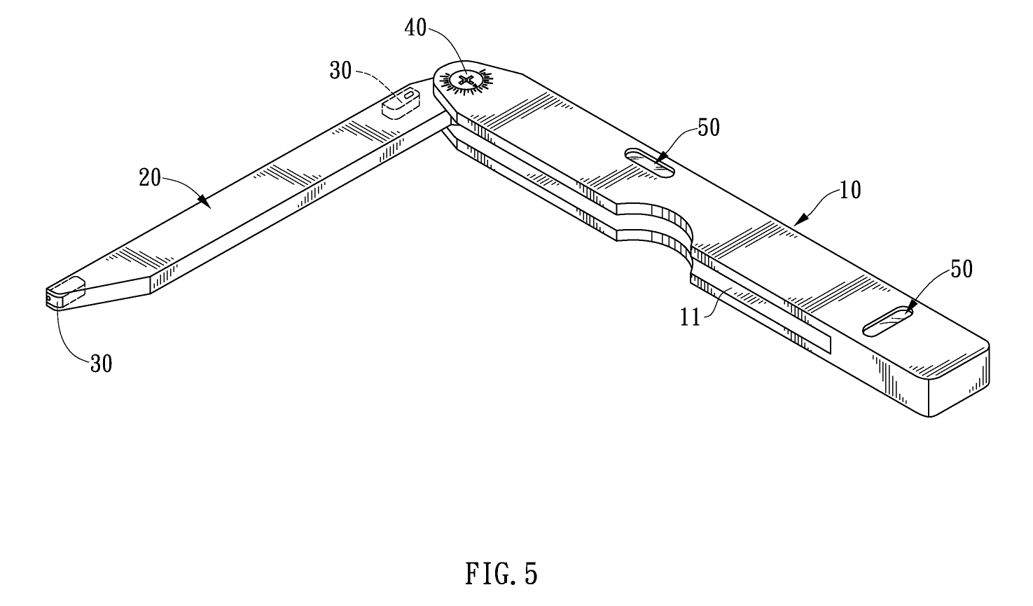

Referring to FIG. 5, there is shown an angle square according to a second embodiment of the present invention. The second embodiment is like the first embodiment except including a second light-projecting element 30 located in the first end of the pivotal ruler 20. The first and second light-projecting elements 30 cast opposite light beams. The second embodiment is particularly useful in measuring the angle of two separated but aligned objects with a third object.

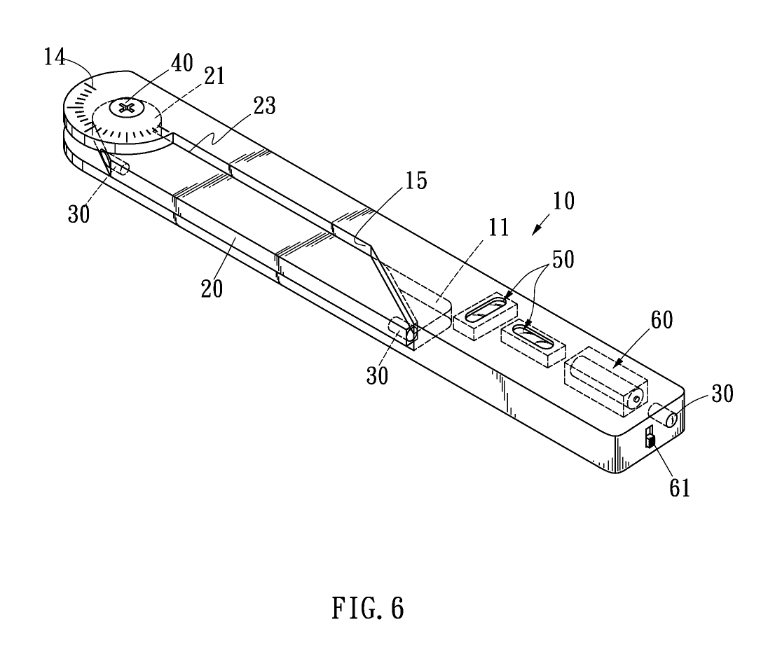

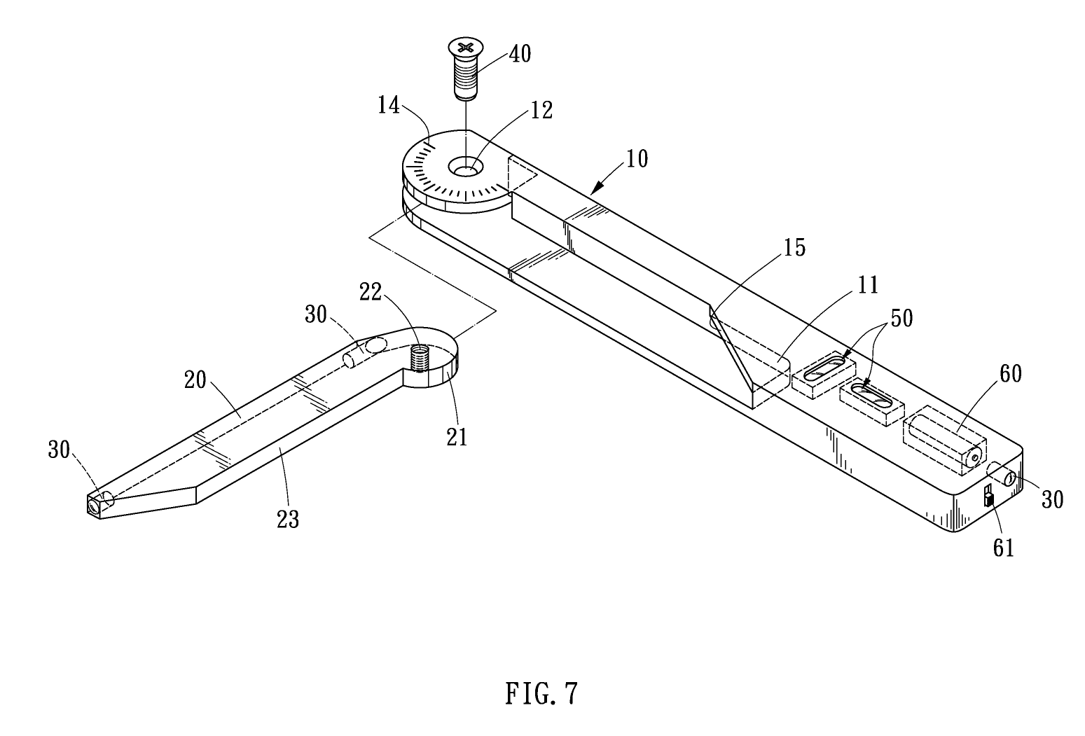

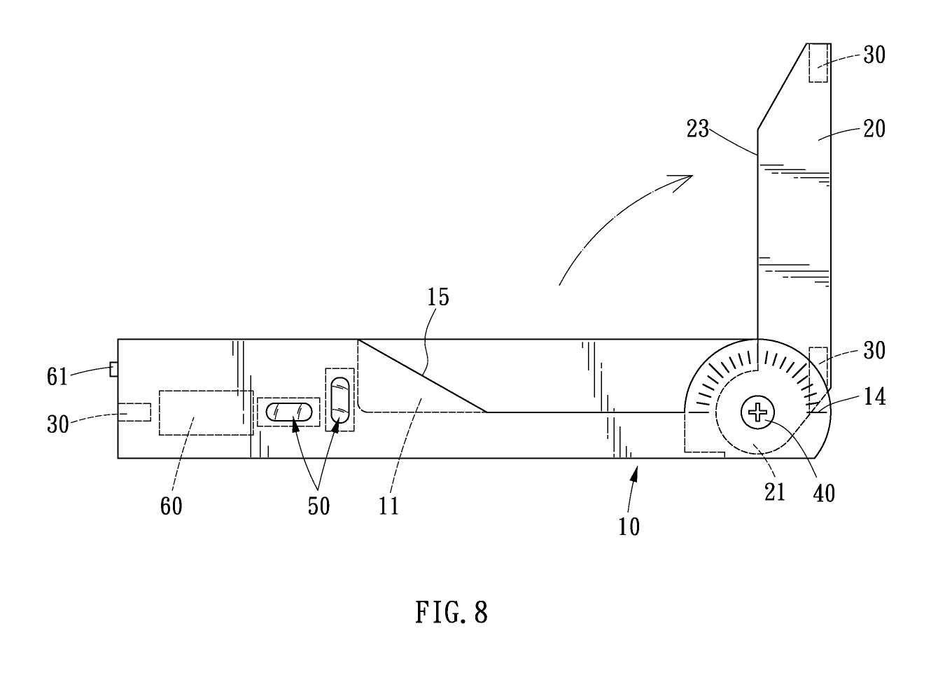

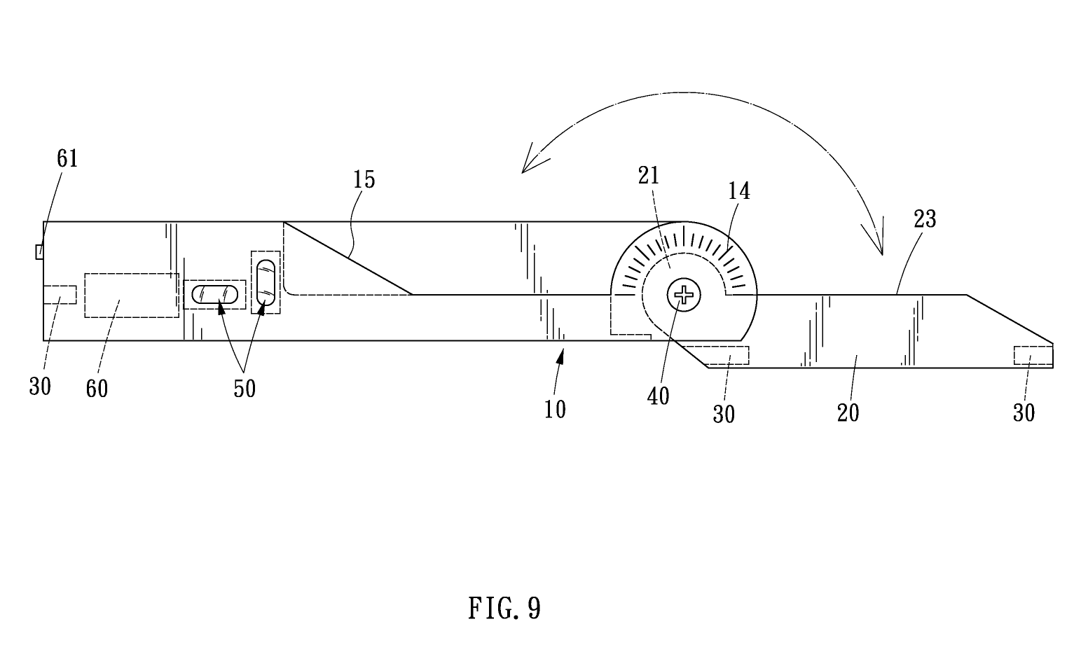

Referring to FIGS. 6 through 9, there is shown an angle square according to a third embodiment of the present invention. The third embodiment is like the second embodiment except several things. At first, a third light-projecting element 30 is located in the second end of the basic ruler 10. Secondly, the levels 50 are located in different positions. Thirdly, a power supply chamber 60 is defined in the basic ruler 10 near the second end. A switch 61 is located at the second end of the basic ruler 10. The switch 61 is electrically connected to several elements (not shown) located in the power supply chamber 60. At least one battery is located in the power supply chamber 60. The switch 61 is operable to use the battery to energize the third light-projecting element 30. Fourthly, a cutout 15 is defined in one of the lateral walls to facilitate the movement of the pivotal ruler 20 from the space 11. Fifthly, scale 14 is used instead of the scale 13. The scale 14 covers only 180°. The scale 14 is used together with the active edge 23 of the pivotal ruler 20, instead of the indicator 41 of the screw 40, to provide the reading of the angle between the active edge of the basic ruler 10 and the active edge 23 of the pivotal ruler 20.

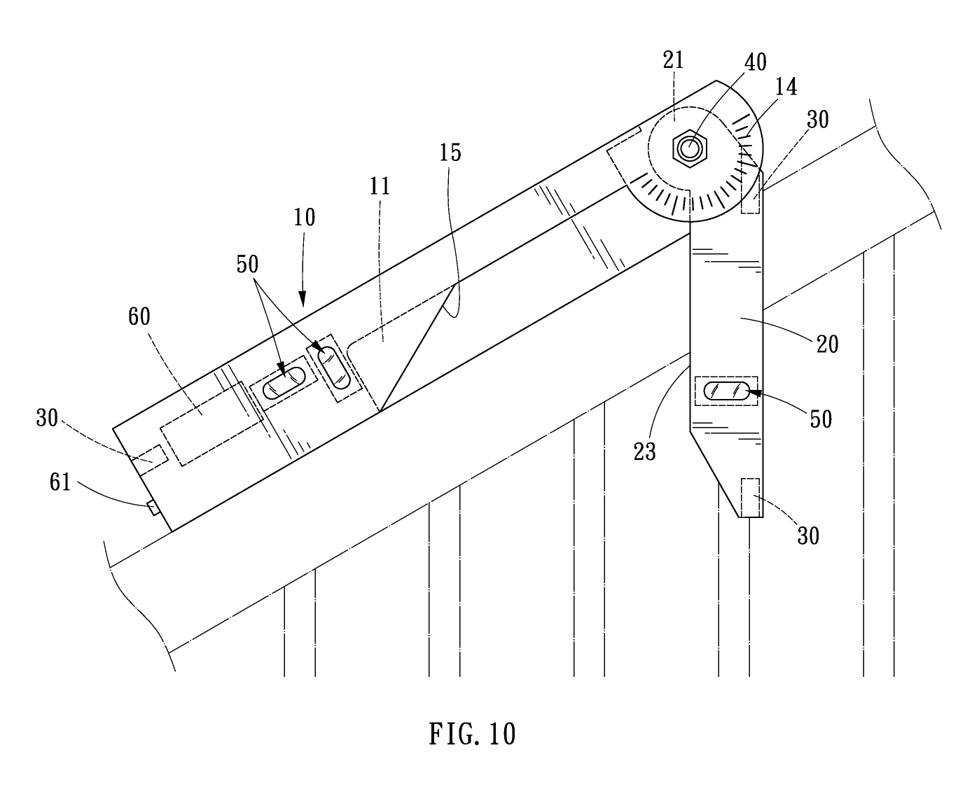

Referring to FIG. 10, there is shown an angle square according to a fourth embodiment of the present invention. The fourth embodiment is like the third embodiment except including a third level 50 on the basic ruler 10. In use, the basic ruler 10 is located against a ladder. It is determined whether the pivotal ruler 20 is vertical or not by observing the third level 50. The active edge 23 of the pivotal ruler 20 is used together with the scale 14 to determine the slope of the ladder.

The angle square of the present invention is convenient and precise. In addition, the angle square can be used as a ruler used in an operation of cutting a piece of a material such as a steel board and a wood board. Thus, there is no need for exchange of tools.

The present invention has been described via the detailed illustration of the embodiments. Those skilled in the art can derive variations from the embodiments without departing from the scope of the present invention. Therefore, the embodiments shall not limit the scope of the present invention defined in the claims.

1. An angle square including:
a basic ruler including a space defined therein;
a pivotal ruler pivotally connected to the basic ruler between an idle position in the space and an active position out of the space;
a light-projecting element connected to the pivotal ruler.

2. The angle square according to claim 1, further including another light-projecting element attached to the pivotal ruler so that the light-projecting elements project opposite light beams.

3. The angle square according to claim 1, further including a level connected to the basic ruler.

4. The angle square according to claim 1, further including a screw driven in the pivotal ruler through the basic ruler so that the screw spins together with the pivotal ruler relative to the basic ruler.

5. The angle square according to claim 4, wherein the basic ruler includes a scale formed thereon, wherein the screw includes an indicator used together with the scale to show a reading of the angle between the basic and pivotal rulers.

6. The angle square according to claim 1, wherein the basic ruler includes a scale formed thereon, wherein the pivotal ruler includes an active edge used together with the scale to show a reading of the angle between the basic and pivotal rulers.

7. An angle square including:
a basic ruler including a space defined therein;
a pivotal ruler pivotally connected to the basic ruler between an idle position in the space and an active position out of the space;
a light-projecting element connected to the basic ruler; and
another light-projecting element connected to the pivotal ruler.

8. The angle square according to claim 7, further including two levels connected to the basic ruler.

9. The angle square according to claim 8, wherein two levels extend in perpendicular to each other.

10. The angle square according to claim 7, wherein the basic ruler includes a cutout in communication with the space to facilitate the movement of the pivotal ruler from the space.

11. The angle square according to claim 7, wherein the basic ruler includes a power supply chamber defined therein for receiving a battery and a switch located thereon.

12. The angle square according to claim 7, further including another light-projecting element located on the pivotal ruler so that the light-projecting elements located on the pivotal ruler cast opposite light beams.

13. The angle square according to claim 7, further including a screw driven in the pivotal ruler through the basic ruler so that the screw spins together with the pivotal ruler relative to the basic ruler.

14. The angle square according to claim 13, wherein the basic ruler includes a scale formed thereon, wherein the screw includes an indicator used together with the scale to show a reading of the angle between the basic and pivotal rulers.

15. The angle square according to claim 7, wherein the basic ruler includes a scale formed thereon, wherein the pivotal ruler includes an active edge used together with the scale to show a reading of the angle between the basic and pivotal rulers.
